(19) United States
(12) Patent Application Publication
(10) Pub. No.: US 2012/0111589 A1
(43) Pub. Date: May 10, 2012

(54) Hand-held power tool with an anti-theft device

(75) Inventors: Peer Schmidt, St. Gallen (CH); Thomas Wirz, Pfaeffikon (CH)

(73) Assignee: Hilti Aktiengesellschaft, Schaan (LI)

(21) Appl. No.: 13/136,713

(22) Filed: Aug. 9, 2011

(30) Foreign Application Priority Data
Aug. 10, 2010 (DE) DE102010039106.9

(51) Int. Cl. B25F 5/00; B23Q 15/00

(52) U.S. Cl. 173/1; 173/2

(57) ABSTRACT

A control method for a hand-held power tool, in response to the actuation of a main switch of the hand-held power tool, carries out the following steps. An identification of transponders in the vicinity of the hand-held power tool is requested in that a transmitter transmits a radio signal. The identification of the at least one responding transponder is received by a receiver. The received identifications are compared to one or more identifications that are stored in a memory unit. The hand-held power tool is switched on if at least one of the identifications stored in the memory unit matches at least one of the received identifications.

This claims the benefit of German Patent Application DE 10 2010 039 106.9, filed Aug. 10, 2010 and hereby incorporated by reference herein.

The invention relates to a hand-held power tool with an anti-theft device, and it also relates to a control method for a hand-held power tool having an anti-theft device.

### SUMMARY OF THE INVENTION

An object of the present invention is to provide a control for a hand-held power tool carrying out the following steps in response to the actuation of a main switch of the hand-held power tool, or in response to the hand-held power tool being connected to a power source. An identification of transponders in the vicinity of the hand-held power tool is requested in that a transmitter transmits a radio signal. The identification of the at least one responding transponder is received by means of a receiver. The received identifications are compared to one or more identifications that are stored in a memory unit. The hand-held power tool is switched on if at least one of the identifications stored in the memory unit matches at least one of the received identifications.

The present invention provides an anti-theft device making use of separate transponders that a user of the hand-held power tool carries along. The anti-theft device recognizes the transponder on the basis of its unambiguous identification and releases the hand-held power tool if the appertaining transponder is in the surroundings or vicinity of the hand-held power tool. The surroundings are defined by the range of the radio signals, which are preferably dimensioned for a small range of 100 meters at the maximum. The anti-theft device can be activated by the main switch. As an alternative, the anti-theft device automatically starts searching for transponders as soon as the hand-held power tool is provided with power, for example, when the hand-held power tool is plugged into a socket or when a battery is placed into the hand-held power tool.

One embodiment provides that, when an operating element is actuated, the following steps are carried out. The transmitter transmits a radio signal in order to request the identification of transponders in the vicinity of the hand-held power tool. The identification of the responding transponders is received by means of the receiver. The received identifications are compared to the identifications that are stored in the memory unit. The received identifications are stored in the memory unit if at least one of the identifications stored in the memory unit matches at least one of the received identifications.

The user is not dependent on a transponder that was delivered with the hand-held power tool. Another device that has the capability to execute the same protocols as the transponder can be used to authorize the operation. The unambiguous identifier of the other device is read in by the anti-theft device of the hand-held power tool if the user has already identified himself to the hand-held power tool by means of the already previously known transponder.

One embodiment provides that a timer is reset if at least one of the identifications stored in the memory unit matches at least one of the received identifications, and, in response to the actuation of a main switch of the hand-held power tool, the hand-held power tool is switched on, irrespective of whether at least one of the identifications stored in the memory unit matches at least one of the received identifications, as long as a period of time specified by the timer has not yet ended.

The authorization of the user by the transponder is valid for a specified period of time, for example, for at least one hour, preferably for up to 10 hours. The timer records when a user has identified himself for the last time by means of an authorized transponder and allows him to use the tool until the end of the period of time, irrespective of whether he is carrying along the transponder or not.

One embodiment provides that, when a reset mode is selected by the user, an encoding unit generates a code, a display unit outputs the code, and the encoding unit deactivates the anti-theft device when a user enters a correct release code in response to the code that has been output. The reset preferably deletes all of the stored identifications, as a result of which the anti-theft device is switched off.

A hand-held power tool having a main switch for operating the hand-held power tool, having an anti-theft device comprising a radio transmitter that transmits a radio signal to transponders in order to request an identification, a radio receiver that receives a radio signal with the identification of the transponders, an evaluation unit which emits a release signal if one of the received identifications matches the identifications stored in a memory unit, and which otherwise emits a blocking signal, and also having a switching device that, in response to the blocking signal, prevents the hand-held power tool from being operated.

### BRIEF DESCRIPTION OF THE DRAWINGS

The description below explains the invention on the basis of figures and embodiments by way of an example. The figures show the following:

FIG. 1 a hand-held power tool.

### DETAILED DESCRIPTION

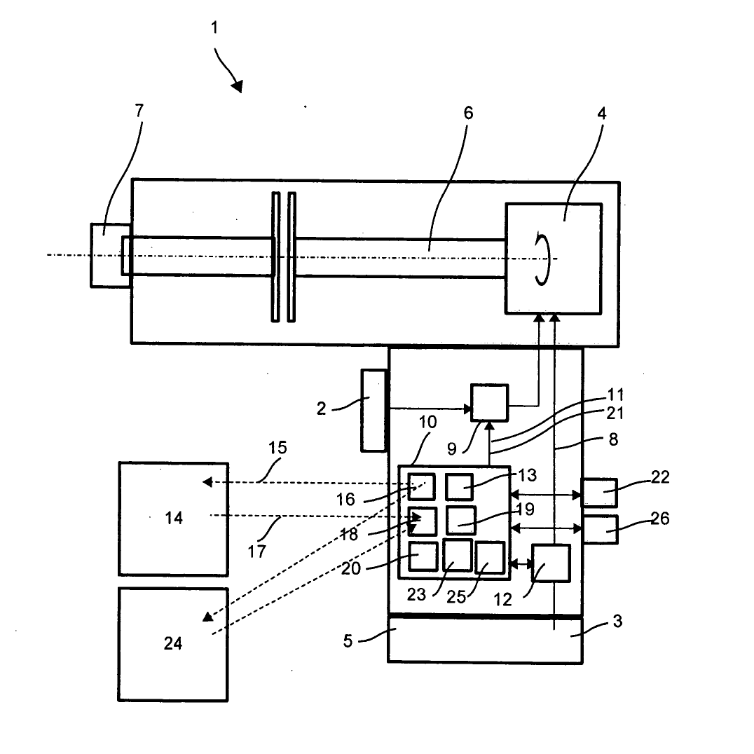

FIG. 1 shows a hand-held power tool 1, for example, an electric screwdriver, a hammer drill, a power drill, a power saw. A user can operate the hand-held power tool 1 by means of a main switch 2. The main switch 2 is connected, for example, in a current path between a power source 3 and an electric motor 4 of the hand-held power tool 1. The power source 3 can be, for example, a battery pack 5 or a mains connection. When the main switch 2 is actuated, the motor 4 starts. A drive train 6 transmits the driving force of the motor 4 to a tool-receiving socket 7 and to a tool held in it. In an alternative embodiment, the main switch 2 activates a motor control 9, for example, of a brushless electric motor. In the case of a combustion motor, the main switch 2 can activate an injection system.

The anti-theft device 10 is activated by the main switch 2. By emitting a blocking signal 11, the anti-theft device 10 can prevent the motor 4 from starting. An autonomous switch element 12 of the anti-theft device 10 can be interconnected, for instance, in the current path 8 and, in response to the blocking signal 11, it can interrupt the power supply. As an alternative, the blocking signal 11 can deactivate the motor control 9 or the injection system.

The anti-theft device 10 can also be activated automatically. A timer 13 activates the anti-theft device 10 at regular intervals, for example, every 30 minutes or every hour. The activation is preferably carried out when the hand-held power tool 1 is connected to a power source 3.

The anti-theft device 10 of the hand-held power tool 1 recognizes an authorized user on the basis of an additional transponder 14 that the user carries along separately from the hand-held power tool 1. The transponder 14 is, for example, a standard transponder according to the IEEE 802.15 standard (Bluetooth), which is present in many mobile telephones. As an alternative, the transponder 14 is contained in a device made specifically for the use of the anti-theft device 10. The transponder 14 has an unambiguous identification, for example, an alphanumeric code that is preferably unique for each transponder 14.

When the anti-theft device 10 is activated, it transmits a radio signal 15 in order to request the unambiguous identification from the transponder 14. The radio signal 15 is transmitted at a suitable frequency, modulation, etc. that is harmonized with the type of transponder 14 and with its protocols; in the present example, this is the IEEE 802.15 standard. The strength of the radio signal 15 can be dimensioned in accordance with the standards for a short-range radio, or else it can be transmitted at an initially lower strength and increased incrementally until a response to the radio signal 15 is received for the first time. A transmitter 16 of the anti-theft device 10 can be set up, for example, to transmit in a frequency range between 2 and 2.5 GHz.

The transponder 14 responds to the requesting radio signal 15 by emitting a responding radio signal 17 in which its unambiguous identification is encoded. A receiver 18 of the anti-theft device 10 receives the responding radio signal 17 of the transponder 14.

An evaluation unit 19 of the anti-theft device 10 compares the received identification to identifications of authorized transponders. The identification of the authorized transponders 14 are stored in a memory unit 20 of the anti-theft device 10. If the received identification matches one of the authorized identifications, the anti-theft device 10 releases the hand-held power tool 1 so that it can be operated. The anti-theft device 10 can emit, for example, a release signal 21 to the motor control 9. If the received identification does not match any of the authorized identifications, then the anti-theft device 10 searches for other transponders 14. A search for other transponders 14 is ended if no transponder 14 with one of the authorized identifications responds within a specified period of time, for instance, 1 minute, or else until the signal strength of the requesting radio signal 15 reaches a specified upper limit. The anti-theft device 10 recognizes this as a possible impermissible use of the hand-held power tool 1. The anti-theft device 10 emits the blocking signal 11 and prevents the operation of the hand-held power tool 1.

In the delivered state, the memory unit 20 can be without any stored identifications. The anti-theft device 10 is deactivated in the case of such an empty memory unit 20. In order for the user to be able to store the identification of a desired transponder 14 in the memory unit 20, the anti-theft device 10 provides for an activation function. The activation function can be selected by an operating element 22, for example, by a single button, on the anti-theft device 10. The anti-theft device 10 searches for transponders 14 in the vicinity, for example, a mobile telephone held by a user in the vicinity of the hand-held power tool 1, and enters its identification into the memory unit 20. The anti-theft device 10 is activated in this manner.

A user can use a modification or augmentation function in order to authorize additional transponders 14 for the anti-theft device 10. This function can be selected by pushing the button 22. The anti-theft device 10 searches for one of the authorized transponders 14 and for a transponder 24 that has not yet been authorized. The anti-theft device 10 emits a requesting radio signal 15 in order to receive the identification of the transponder 14, 24. First of all, the anti-theft device 10 checks whether one of the received identifications matches one of the authorized identifications stored in the memory unit 20. If this is the case, the identification that was not yet stored in the memory unit 20 is then stored in the memory unit 20. From that point on, the user can operate the hand-held power tool 1 if he carries along the new transponder 24 instead of or in addition to the previous transponder 14. This can be useful, for instance, if a user wishes to replace one mobile telephone for another mobile telephone.

The operating element 22 allows the user to delete the list of authorized identifications in the memory unit 20. For this purpose, the user has to carry along at least one of the authorized transponders 14. After the user has used the operating element 22 to select the function of deleting the memory unit 20, the anti-theft device 10 checks whether an authorized transponder 14 is present. If an identification of a transponder 14 that is stored in the list of authorized identifications in the memory unit 20 is ascertained by means of the requesting radio signal 15, all of the identifications in the memory unit 20 are deleted. Preferably, the one identification of the transponder 14 that is present can be entered once again into the memory unit 20 or else it is not deleted from the memory unit 20.

The anti-theft device 10 can comprise a timer 23. After the anti-theft device 10 has ascertained that a received identification matches one of the authorized identifications stored in the memory unit 20, the timer 23 can be reset. The hand-held power tool 1 can be operated for a period of time specified by the timer 23, for example, for 10 hours. Only after this period of time is there a need for an authorized transponder 14 in order to operate the hand-held power tool 1. The evaluation unit 19 checks whether the period of time of the timer 23 has ended. If this is not the case, then the anti-theft device 10 releases the hand-held power tool 1. The use of the hand-held power tool 1 can be authorized, for example, at the beginning of the work day. Then, there is no need to continuously carry along an authorized transponder 14.

In another embodiment, the transponder can be, for example, an RFID chip. The RFID chip is activated by the requesting radio signal 15 and it outputs an identification that is stored in the RFID chip. Alternative transponders that, in response to radio signals, especially to radio signals having a short range of a few meters up to 100 meters, output an unambiguous identification are suited for the method described above.

If a user loses all of the authorized transponders 14, then, to start with, he can no longer operate the hand-held power tool 1. A reset function is provided for this purpose. The user selects a reset function by means of the operating element 22. This can require, for example, a special sequence of pressing and releasing the operating element 22, for instance, pressing it five times. An encoding unit 25 generates a code that is preferably only valid for a limited period of time. The code can be generated, for example, by a random generator. A display element 26, for example, a single LED, of the anti-theft device 10 outputs the code as a blinking signal. Based on this code, the user can request a release code from a service provider. The release code can be entered by means of the operating element 22 as a sequence of pressing and releasing. The encoding unit 25 modifies the release code in accordance with an algorithm and compares the result to the code that has been output. If they match, all of the identifications are deleted from the memory unit 20. In this status, the hand-held power tool 1 can be operated without transponders 14. The anti-theft device 10 is switched off.

1. A control method for a hand-held power tool, the hand held power tool, in response to actuation of a main switch of the hand-held power tool, or in response to the hand-held power tool being connected to a power source, carries out the following steps:
requesting identification of transponders in a vicinity of the hand-held power tool via a transmitter transmitting a radio signal;
receiving the identification of the at least one responding transponder via a receiver;
comparing the received identifications to one or more identifications stored in a memory unit; and
releasing an activation of the hand-held power tool by an evaluation unit if at least one of the identifications stored in the memory unit matches at least one of the received identifications.

2. The control method as recited in claim 1 further comprising, when an operating element is actuated, the following steps are carried out:
requesting identification of the transponders in the vicinity of the hand-held power tool via the transmitter transmitting a further radio signal;
receiving identifications of any responding transponders via the receiver;
comparing received identification to the identifications stored in the memory unit; and
storing the received identifications in the memory unit if at least one of the identifications stored in the memory unit matches at least one of the received identifications.

3. The control method as recited in claim 1 wherein a timer is reset if at least one of the identifications stored in the memory unit matches at least one of the received identifications, and, in response to the actuation of a main switch of the hand-held power tool, the hand-held power tool is switched on, irrespective of whether at least one of the identifications stored in the memory unit matches at least one of the received identifications, as long as a period of time specified by the timer has not yet ended.

4. The control method as recited in claim 1 wherein, when a reset mode is selected by the user, an encoding unit generates a code, a display unit outputs the code, and the encoding unit prompts the evaluation unit to release the activation of the hand-held power tool when a user enters a correct release code in response to the code that has been output.

5. A hand-held power tool comprising:
a main switch for operating the hand-held power tool;
an anti-theft device comprising a transmitter transmitting a radio signal to transponders in order to request an identification, a receiver receiving a radio signal with the identification of the transponders, an evaluation unit emitting a release signal if one of the received identifications matches the identifications stored in a memory unit, and otherwise emitting a blocking signal; and
a switch, the switch, in response to the blocking signal, preventing the hand-held power tool from being operated.
